(19) United States
(12) Patent Application Publication
(10) Pub. No.: US 2010/0001444 A1
(43) Pub. Date: Jan. 7, 2010

(54) AIR SPRING FOR A VEHICLE

(76) Inventor: Karsten Weber, Aschaffenburg (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/374,583

(22) PCT Filed: Aug. 7, 2007
(86) PCT No.: PCT/EP2007/006978

§ 371 Date: Jan. 21, 2009

(30) Foreign Application Priority Data
Aug. 8, 2006 (DE) 10 2006 037 034.1

(51) Int. Cl. F16F 9/05

(52) U.S. Cl. 267/64.21

(57) ABSTRACT

An air spring for a vehicle comprises an air bellows that includes an axle-side region and a superstructure-side region movable with respect to one other between a first, adjacent position and a second, spaced-apart position, and a plunger which is arranged on the axle-side region of the air bellows. The air spring further comprising a fastening section adapted to fasten the superstructure-side region of the air bellows to a support element of the vehicle, and a displacement element which is arranged on the fastening section of the air bellows, wherein the displacement element fills at least a substantial portion of the space between the plunger and the fastening section in the first position of the air bellows.

### BACKGROUND OF THE INVENTION

1. Field of the Invention

The present invention pertains to an air spring for a vehicle, especially for a commercial vehicle, as well as a vehicle axle system with an essentially rigid axle body, in which the air spring is integrated.

2. Technical Background

Air spring systems for vehicles, especially for commercial vehicles or trucks, are familiar in the prior art. These systems consist of a pneumatic system with controls and an air bellows or an air spring, basically consisting of a plunger, an air spring bellows, a bumper element and a cover plate, wherein the plunger can plunge into the air spring bellows for a height adjustment. It is desirable that the functioning of the air spring is not impaired by loading the vehicle (e.g., by means of a crane). Thus, it is customary to lower the vehicle until the plunger strikes against a bumper element, so that the air spring bellows is essentially fully retracted. Next, blocking of an air intake inside the air spring bellows results in the air spring bellows basically supporting the axles when the vehicle is raised. As the vehicle is raised further, however, the axles pull the plungers of the air spring bellows down somewhat on account of their weight, so that a partial vacuum is produced inside them, which prevents further rebounding of the axles. Yet the problem here is that, due to the large difference in pressure between the interior of the air spring bellows and its surroundings, the air spring bellows has a tendency to become crumpled or constricted. This means that when the vehicle is put down once more, parts of the air spring bellows can become crimped or jammed and will thus become damaged and no longer work properly. Solutions for this problem are known in the prior art. Thus, it is known, for example, how to provide a divided plunger, whose lower part separates from the air spring bellows when the axle is lowered (i.e., external lifting of the vehicle) and thus does not drag air spring bellows along. Likewise known are so-called splitter arrangements, for example, from EP 0 446 709 B1, in which the cover plate of the air spring bellows is not rigidly connected to the vehicle frame, but instead guided on a movable rocker arm. Finally, it is known from the prior art how to prevent a complete rebounding of the axle by means of catch cables, although these cables also prevent a complete lifting of the vehicle by means of the air spring bellows.

Thus, the problem of the present invention is to provide an air spring for a vehicle, especially a commercial vehicle, as well as a vehicle axle system in which the above-mentioned crimping effect and the associated disadvantages are prevented.

### SUMMARY OF THE INVENTION

One aspect of the present invention is an air spring for a vehicle comprising an air bellows or air spring bellows, which has an axle-side region and a superstructure-side region, which regions are movable with respect to each other between a first, adjacent position and a second, spaced-apart position, a plunger which is arranged on the axle-side region of the air bellows, a fastening section in order to fasten the superstructure-side region of the air bellows to a support element of the vehicle, and a displacement element which is arranged on the fastening section of the air bellows, wherein the displacement element essentially fills the space between the plunger and the fastening section in the first position of the air bellows. Thus, the air spring can be provided for a vehicle, such as a commercial vehicle, a truck, a trailer, etc.

The air bellows is cylindrical in shape in its ground state, when it is not influenced by external forces, i.e., a hoselike shape. The air bellows has an axle-side region, i.e., a region provided at distal end thereof that is designed to be mounted on the vehicle at the axle side. The air bellows also includes a superstructure-side region, i.e., a distal end thereof, which is basically opposite the axle-side region and designed to be mounted on the vehicle at the superstructure side.

The axle-side region and the superstructure-side region can move relative to each other between a first, adjacent position and a second, spaced-apart position. The movement of the two distal regions of the air bellows occurs basically in a linear fashion, but it can likewise be a movement along a curve. The direction of movement in this case corresponds to the spring direction. As a rule, the movement of the plunger does not exactly follow a straight line, but rather a slightly curved line, since the air spring bellows is generally used so that the axle-side region thereof moves on a circular orbit, which is defined by the longitudinal arm of the axle. In the second, spaced-apart position, the air bellows has an essentially cylindrical configuration. In the first, adjacent position, axle-side and superstructure-side region are arranged with the minimum possible spacing from each other. In this case, the air bellows basically has a configuration consisting of at least two essentially coaxially arranged cylindrical surfaces, since the plunger with the axle-side region of the air bellows fastened to it plunges into the air bellows, i.e., the plunger is thus arranged on the axle-side region of the air bellows in such a way that a movement of the plunger results in a corresponding movement of the axle-side region of the air bellows. Opposite this, the superstructure-side region of the air bellows is arranged or fastened to a support element or frame element of the vehicle via a fastening section.

The fastening section can be a single piece in configuration and/or integrated with the air bellows, so that the fastening section is part of the air bellows. In this configuration, the air bellows is thus cylindrical in its ground state, and at least one end face is closed off preferably air-tight by the fastening section. In an alternative embodiment, the fastening section is configured separate from the air bellows and connected to it preferably in an air-tight manner. The displacement element is arranged on the fastening section of the air bellows in such a way that it is located inside the air bellows, i.e., in the space surrounded by the air bellows.

The displacement element is dimensioned so that, in the first position of the air bellows, when the air bellows encloses the least volume, the displacement element at least partially fills the space between the plunger and the fastening element looking in the direction of the spring. The displacement element may be configured as a support and/or bumper element, in order to transmit the gravity force of the vehicle superstructure onto the vehicle axle system when the air bellows is totally emptied. The structural space between the distal end of the plunger and the fastening section is filled in the first position of the air bellows, so that the remaining residual volume is very small in relation to the total volume of the air bellows in its second position. As a result, the force needed to extend the air bellows against the atmospheric pressure acting from the outside is increased such that it lies considerably above the force caused by the mass of the axle. Due to the very small residual volume in the air bellows brought about by the displacement element in its first position, the ratio of the volume change to change the mutual spacing of the axle-side region and superstructure-side region and thus the force needed to space apart the axle-side and superstructure-side region is relatively large. This dictates, in particular, the distance by which the plunger is drawn downward until an equilibrium of weight prevails when the vehicle is lifted. The air spring allows this distance to be kept relatively small, such that the stiffness of the side wall in the superstructure-side region of the air bellows can be configured smaller.

Preferably, the displacement element has a geometrical configuration essentially in the shape of a cone, specifically a truncated cone. The displacement element in its cross section viewed essentially perpendicular to the spring direction can subtend an essentially circular area, but it can also subtend an angular or polygonal area. The displacement element can be arranged in the air spring so that its tapering region faces the plunger.

The tapering region of the displacement element is fastened on the fastening section of the air bellows. Consequently, a region of larger cross section is facing the plunger. This conical configuration facilitates the retraction, i.e., the positioning of the air bellows in the first position, if at the moment of the lowering there exists a horizontal lateral offset between the plunger and the fastening section, i.e., the plunger and the fastening section are not lined up with each other along the spring direction. The air spring is provided so that the plunger and the fastening section are precisely one above the other at the working point (i.e., driving height), that is, they are lined up with each other along the spring direction, so that the axis of the plunger points in the direction of the normal to the fastening section. In the lowered condition, i.e., the first position of the air bellows, the circular path on which the plunger moves on the longitudinal arm of the axle produces an angle and a center offset between the plunger and the fastening section. Due to the conical shape of the displacement element, this offset is compensated in such a way that a frictionless movement into the air bellows is made possible.

The displacement element can be configured with rotational symmetry. To allow for the angle and the offset, the displacement element can likewise be asymmetrical in configuration, i.e., basically formed by two ground surfaces not running parallel to each other, so that the displacement element has the shape of a wedge. A double mirror symmetry configuration can also be advantageous.

Preferably, the surface of the displacement element facing the plunger is at least partly concave in configuration. Thus, the surface of the plunger facing the displacement element can have, for example, an essentially annular recess. Alternatively or additionally, the surface of the displacement element facing the plunger can be configured concave overall, and can have a recessed spherical surface configuration. In this way, it is possible to position the plunger axially in relation to the displacement element when the plunger strikes against the displacement element, i.e., to position it in a plane perpendicular to the spring direction.

The displacement element can at least partly encloses the plunger in the first position of the air bellows. In other words, the plunger is at least partly surrounded by the displacement element. The displacement element is arranged at least partly between the outer circumferential wall of the plunger and the superstructure-side region of the air bellows or a region adjoining the latter. Thus, the residual volume of the air bellows is further reduced in its first position. With a concave configuration of the displacement element, the displacement element basically takes over the function of a kind of cover, which covers or encloses or surrounds or spans the distal end of the plunger facing the displacement element and at least a part of the adjoining lateral circumferential wall of the plunger when the air spring is retracted, i.e., first position of the air bellows.

Advisedly, the displacement element has an essentially curved, preferably round circular cross section shape. Thus, the cross section is defined essentially perpendicular to the spring direction. The cross section shape of the displacement element corresponds essentially to that of the air bellows.

The displacement element is formed from a material which can rebound. This is especially advantageous for an air bellows in the first position, when the displacement element is preferably lying against the plunger and thus the gravity force produced by the superstructure of the vehicle is conveyed directly across the displacement element and the plunger to the vehicle axle system. This assures at least some residual spring action in the system.

Preferably, the displacement element consists of a material whose density is essentially at least 1.1 kg m³, more preferably at least 1.2 kg/m³. Also, preferably, the displacement element consists of a material whose density is greater than the density of the fluid or gas supplied to the air bellows, thereby assuring that the gas located in the air bellows is displaced by the displacement element. Additionally or alternatively, the displacement element can also be configured essentially hollow, in which case the shell of the displacement element is fashioned basically fluid or gas-tight.

Preferably, the fastening section is configured as a cover plate arranged at the distal superstructure-side region of the air bellows. The cover plate is advantageously fastened to the air bellows in such a way that a fluid or gas-tight connection is provided between cover plate and air bellows.

The fastening section and the displacement element can be configured as separate elements. Preferably, however, the fastening section and the displacement element are configured as one part or one piece.

In another embodiment, the fastening section is configured as a cover cylinder arranged on the distal superstructure-side region of the air bellows, whose side wall is basically rigid. Thus, the fastening section or cover cylinder is essentially fashioned as a container or pot that receives at least part of the plunger in an interior thereof in the first position of the air bellows. In other words, a side wall of the cover cylinder in the first position of the air bellows encloses at least part of the plunger. At the edge of the cover cylinder, the superstructure-side region of the air bellows is preferably fastened. Consequently, a portion of the air bellows in the upper, superstructure-side region is replaced by a rigid part, i.e., the cover cylinder. Consequently, this region cannot be crimped or constricted, due to the rigid or stiff side wall. In other words, the cross section in this region remains essentially constant, regardless of the loading condition.

In another embodiment, the air bellows has stiffening elements, at least in the superstructure-side region, in order to heighten the radial stiffness of the air bellows. The stiffening elements can be configured as a carcass ply, a reinforcement ply, rings of steel or steel braiding, which is inserted or vulcanized into the material of the air bellows. In this way, a radial stiffness is assured without limiting the axial and lateral mobility of the air bellows, and counteracts any constricting or bulging in the direction of the center of the air bellows.

Preferably the air bellows has at its end or adjacent to the axle-side region a first engaging means or coupler portion, which is designed to engage with a second engaging means or coupler portion of the plunger. Thus, one can provide an air spring for a vehicle, especially a commercial vehicle, comprising an air bellows, that has an axle-side and a superstructure-side region, and a plunger, which is arranged on the axle-side region of the air bellows, wherein the air bellows has at or adjacent to the axle-side region a first engaging means, which is designed to engage with a second engaging means of the plunger, which is fastened on or adjacent to the distal end of the plunger where the air bellows is fastened. In this way, one can prevent the inner part of the bellows lying against the plunger, i.e., the axle-side region, from sliding upward or being pulled upward past the wall of the plunger in the first position of the air bellows when the vehicle is lifted. This is especially advantageous, since the creases that would otherwise be formed on the one hand would counteract the formation of a vacuum and on the other hand would become jammed above the plunger when the vehicle is lowered. Also advantageously, the air bellows is allowed to roll down until it is fastened on the head of the plunger when the air bellows is moved into the second position.

Preferably, the first engaging means of the air bellows is fashioned as a radial constriction, which is preferably reinforced by a support element. The radial constriction can preferably be created in such a way that a support element in the shape of a ring of steel, a steel braiding, or another stiffening material is arranged on the air bellows or inserted or vulcanized in it, so that a thickening, a bulge or a step results.

Also preferably, the second engaging means of the plunger is fashioned as a radially circumferential groove, which is preferably arranged on or adjacent to the distal end of the plunger. In other words, the groove is arranged at or adjacent to the horn of the plunger or the region of the fastening of the air bellows to the plunger. The groove, in particular, can be provided on a side wall or circumferential wall of the plunger and extend around it in a ring shape. The shape of the groove corresponds to that of the constriction of the air bellows, so that a kind of form fitting results between first and second engaging means, i.e., bellows and plunger, which prevents a slipping of the air bellows on the plunger in the spring direction when the vehicle is lifted. However, the air bellows may still roll down in normal operation, i.e., a movement of the air bellows into the second position, until it is fastened on the head of the plunger.

Consequently, the first and second engaging means are preferably disengaged in the second position of the air bellows.

Preferably, the ratio of the cross sectional area of the air bellows to the cross sectional area of the plunger is basically between 1.1 to 1.5, more preferably essentially between 1.1 to 1.25. The cross section here is defined essentially perpendicular to the spring direction. As a result of the cross-sectional area ratio of such dimension, the volume change per change in the distance of the plunger from the fastening section is large enough that the force needed to further draw apart the air bellows, basically located in the first position, against the atmospheric pressure acting from the outside, is distinctly greater than the force produced by the mass of the axles. This ensures a secure positioning or a secure holding of the axle system when the vehicle is lifted.

A valve device may be provided on the air bellows in order to prevent an intake of air in the air bellows, especially in its first position. Thus, a valve device is created which prevents the working liquid or the air from flowing into the air bellows when the vehicle is being lifted, so that a movement of the air bellows into the second position is basically halted.

The valve device may have at least one valve unit at the outlet of the air bellows. This can be manually or automatically activatable.

Another aspect of the invention is a vehicle axle system with an essentially rigid axle body, and at least one air spring according to the invention is arranged on the axle body as described above.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a cross sectional view of a first embodiment of the invented air spring, and

FIG. 2 is a cross sectional view of a second embodiment of the invented air spring.

### DETAILED DESCRIPTION OF THE PREFERRED EMBODIMENTS

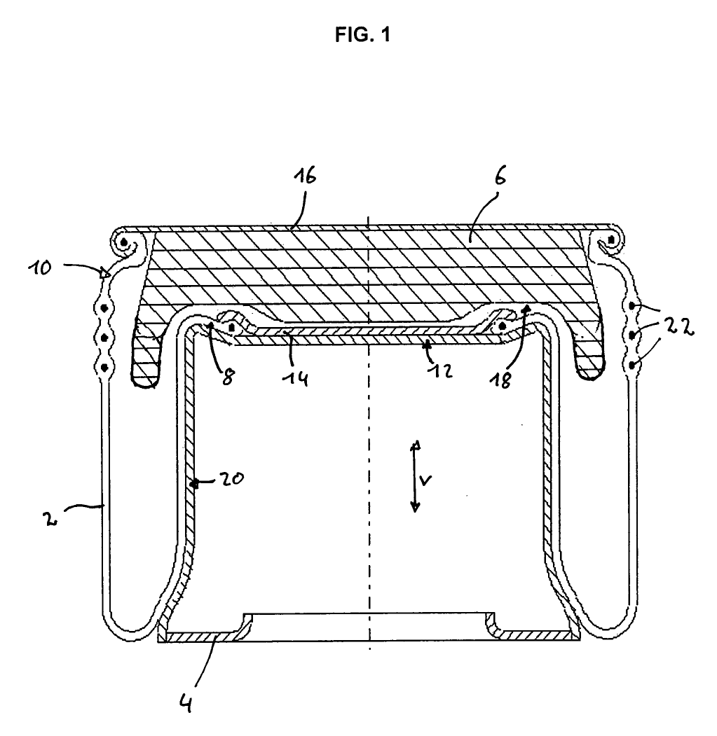

FIG. 1 shows a cross section view of a first embodiment of the invented air spring for a vehicle. The air spring comprises an air spring bellows or air bellows 2, a plunger 4, and a displacement element 6.

The air bellows 2 is substantially cylindrical in form and has an axle-side region 8 and a superstructure-side region 10. The axle-side region 8 lies substantially opposite the superstructure-side region 10. The air bellows 2 can be moved between a first position, shown in FIG. 1, in which the axle-side region 8 and the superstructure-side region 10 are basically standing close to each other, and a second position, in which the axle-side region 8 and the superstructure-side region 10 are so far apart from each other that the air bellows 2 has an essentially hoselike or tubular configuration. The movement of the air bellows between the first and second spaced-apart position occurs essentially along the spring direction v.

The plunger 4 preferably has an essentially cylindrical or conical configuration. The distal end 12 of the plunger 4 has a fastening means 14, to fasten the axle-side region 8 of the air bellows 2 to the plunger 4. The fastening via the fastening means 14 occurs by a wedging or clamping of a bulge provided at the axle-side distal end of the air bellows 2.

The superstructure-side region 10 of the air bellows 2, substantially opposite the axle-side region 8, is fastened to or arranged on a fastening section. The fastening section can be configured as a cover plate 16 arranged at the distal superstructure-side region 10 of the air bellows 2, which closes off the air bellows 2 in the superstructure-side region 10 from the surroundings in essentially fluid- or gas-tight manner. The superstructure-side region 10 of the air bellows 2 can be fastened on a support element or frame element of the vehicle above the fastening section or the cover plate 16. Accordingly, the plunger 4 represents the fastening means of the axle-side region 8 of the air bellows 2 to the axle system of the vehicle.

The displacement element 6 is arranged on or fastened to the fastening section or the cover plate 16. Consequently, no movement of the displacement element 6 occurs during a movement of the axle-side region 8 of the air bellows 2 or the plunger 4, since the displacement element 6 is arranged essentially stationary with respect to the superstructure-side region 10 of the air bellows 2 or with respect to the fastening section or the cover plate 16. The displacement element 6 preferably has essentially the shape of a cone, and with the tapering region of the displacement element 6 being fastened to the fastening section or the cover plate 16. Thus, the region with the greater cross section of the displacement element 6 protrudes into the space enclosed by the air bellows 2, i.e., it faces the plunger 4. Preferably, the displacement element 6 has a concave surface geometry, so that it at least partially encloses the plunger 4 in the first position of the air bellows 2 as shown in FIG. 1. As a result, the space between plunger 4 and fastening section or cover plate 16 is at least partially filled up by the displacement element 6 so that the remaining residual volume in the air bellows 2 is as little as possible. In particular, the displacement element 6 can be concave in configuration so that a surface facing the plunger 4 has an annular recess 18, which additionally serves for the positioning of the plunger 4 in the first position of the air bellows 2. Preferably, the displacement element 6 at least partly protrudes into the space defined between the outer wall or circumferential wall 20 of the plunger 4 (or the axle-side region 8 basically adjacent to it and the neighboring or adjoining region of the air bellows 2) and the superstructure-side region 10 (or the region of the air bellows 2 neighboring or adjoining it), so as to further reduce the residual volume present in the first position of the air bellows 2.

In order to counteract the above-mentioned crimping effect, the air bellows 2 has stiffening elements 22 in or neighboring the superstructure-side region 10. The stiffening elements 22 are provided in particular to heighten the radial stiffness of the air bellows 2, without restricting the axial and lateral mobility of the air bellows 2. The stiffening elements 22 can be fashioned, in particular, as rings of steel, steel braid, or another stiffening material, which is arranged on the air bellows 2 by insertion or vulcanization.

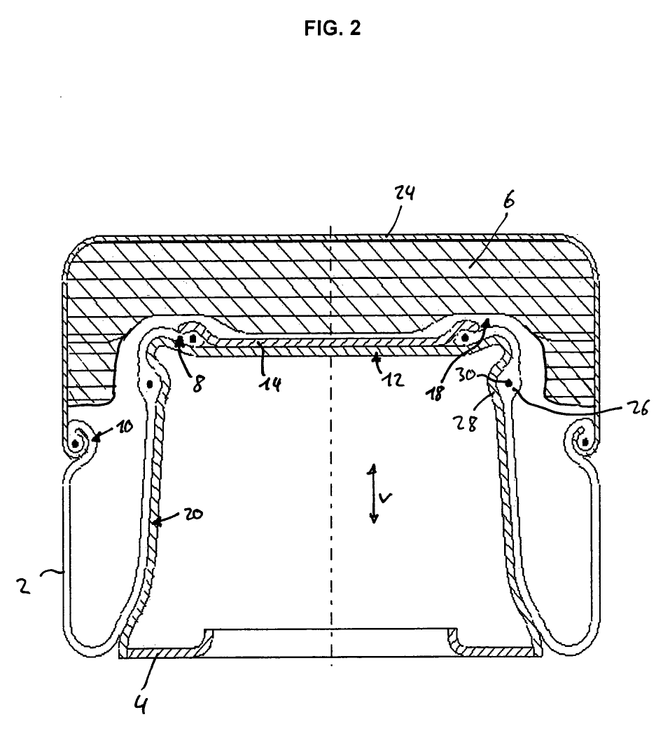

An alternative embodiment of stiffening the outer wall of the air bellows 2 is shown in FIG. 2, where the elements identical to the first embodiment are given the same reference numbers. The fastening section of the alternative embodiment is configured as a cover cylinder 24 arranged at the distal superstructure-side region 10 of the air bellows 2, whose upper end facing the vehicle frame is closed, so as to have the shape of a container or pot. The side wall of the cover cylinder 24 is fashioned essentially rigid or firm and at least partly encloses the plunger 4 in the first position of the air bellows 2. Consequently, a part of the air bellows 2, namely, the outer upper region or superstructure-side region, is replaced by a rigid or firm part, so that the above-mentioned crimping effect or a constriction or bulging on account of the pressure difference between the interior of the air bellows and the surroundings is prevented.

The air bellows 2 as illustrated in FIG. 2 has, at or near the axle-side region 8, a first engaging means 26, which is designed to engage with a second engaging means 28 of the plunger 4. The first engaging means 26 of the air bellows 2 is configured as a radial constriction or thickening or as a bulge or step, and is preferably strengthened by a support element 30. The support element 30 can be a ring of steel, steel braid, or another stiffening material, which is arranged on the air bellows 2 by insertion or vulcanization. The second engaging means 28 is shaped according to the configuration of the first engaging means 26. In particular, the second engaging means 26 is configured as a radially circumferential groove in the plunger 4, which is arranged preferably on or near the distal end 12 of the plunger 4 on the circumferential wall 20. In this way, the air bellows 2 is prevented from slipping on the plunger 4 in the spring direction v when the air bellows 2 is in the first position, while still ensuring that the air bellows 2 can move down until the air bellows 2 is secured on the fastening means 14 at the distal end 12 of the plunger 4, especially in the second position. Consequently, the first engaging means 26 and second engaging means 28 are not engaged in the second position of the air bellows 2.

1-19. (canceled)

20. An air spring for a vehicle, comprising:
an air bellows including an axle-side region and a superstructure-side region, the axle-side region and the superstructure-side region movable with respect to each other between a first position, wherein the regions are substantially adjacent to one another, and a second position, wherein the regions are spaced apart from one another;
a plunger operably coupled to the axle-side region of the air bellows;
a fastening section adapted to fasten the superstructure-side region of the air bellows to a support element of a vehicle, wherein the fastening section cooperates with the plunger to define a space therebetween; and
a displacement element operably coupled to the fastening section of the air bellows and wherein the displacement element substantially fills the space between the plunger and the fastening section and at least partly encloses the plunger when the regions are in the first position.

21. The air spring of claim 20, wherein the displacement element is substantially cone-shaped.

22. The air spring of claim 21, wherein the displacement element includes a tapering region that is fastened to the fastening section of the air bellows.

23. The air spring of claim 20, wherein at least a portion of a surface of the displacement element facing the plunger is concave.

24. The air spring of claim 20, wherein the displacement element has a curved cross-sectional-shape.

25. The air spring of claim 20, wherein the displacement element comprises a substantially elastic material.

26. The air spring of claim 20, wherein the displacement element comprises a material having a density of at least about 1.1 kg/m³.

27. The air spring of claim 20, wherein the fastening section is substantially plate-shaped and is coupled to the distal superstructure-side region of the air bellows.

28. The air spring of claim 20, wherein the fastening section is substantially cylindrically-shaped and is coupled to the distal superstructure-side region of the air bellows.

29. The air spring of claim 20, wherein the air bellows includes stiffening elements that increase the radial stiffness of the air bellows.

30. The air spring wherein the air bellows includes a first portion of a coupler and the plunger includes a second portion of the coupler coupled to the first portion of the coupler.

31. The air spring per claim 30, wherein the first portion of the coupler includes a radial constriction.

32. The air spring of claim 31, wherein the second coupler portion comprises a radially circumferential groove.

33. The air spring of claim 30, wherein the first and second portions of the coupler are disengaged when the regions are in the second position.

34. The air spring of claim 20, wherein the ratio of a cross-sectional area of the air bellows to a cross-sectional area of the plunger between about 1.1 and about 1.5.

35. The air spring of claim 20, further including:
a valve device coupled the air bellows, wherein the valve device prevents an intake of air in the air bellows when the regions are in the first position.

36. The air spring of claim 35, wherein the valve device has at least one valve unit positioned at the outlet of the air bellows.

37. A vehicle axle system comprising:
an essentially rigid body axle; and
at least one air spring as defined in claim 20.

38. The air spring of claim 26, wherein the displacement element comprises a material having a density of at least 1.2 kg m³.

39. The air spring of claim 28, wherein the fastening section includes a substantially rigid sidewall.

40. The air spring of claim 31, wherein the radial constriction is reinforced by a support element.

41. The air spring of claim 32, wherein the radially circumferential groove is located substantially adjacent an end of the plunger.

42. The air spring of claim 34, wherein the ratio of the cross-sectional area of the air bellows to the cross-sectional area of the plunger is between 1.1 and 1.25.
